(19) United States
(12) Patent Application Publication
(10) Pub. No.: US 2004/0066794 A1
(43) Pub. Date: Apr. 8, 2004

(54) Instrument module locator

(76) Inventor: Gregory S. Hill, Santa Rosa, CA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/266,522

(22) Filed: Oct. 8, 2002

(51) Int. Cl. H04B 7/212

(52) U.S. Cl. 370/442

(57) ABSTRACT

A module locator has a generator that provides to each of a series of module slots in a mainframe, a signal having a unique signature. Each module interfacing with a module slot has an associated receiver that receives the signal through the module slot and reads the unique signature of the signal provided by the generator. The unique signatures read by the receivers are typically reported to a host processor associated with the mainframe when queried, so that the location of the module within the series of module slots can be established.

### FIELD OF THE INVENTION

This invention relates to modular instruments, and particularly, to locating modules within module slots of the modular instruments.

### BACKGROUND OF THE INVENTION

Many types of test, measurement and communication systems are implemented in modular instruments that include various types of modules. For example, a typical modular spectrum analysis system has a pre-selector module, a local oscillator (LO) module, an intermediate frequency (IF) module, a power supply module, and numerous other modules configured in module slots within an instrument mainframe. Since each module slot in the mainframe can accept various types of modules and since each type of module typically has unique control signal requirements, it is important to determine which modules are located in which module slots, so that proper control signals can be applied to adjust operating conditions of the various modules within the instrument mainframe.

A first known method used to establish the locations of modules within an instrument mainframe codes each of the modules by selectively grounding designated contacts, or pins, on connectors of each of the modules. Based on this coding, the location of each module within a series of module slots can be determined. However, this method has the drawback that multiple pins are occupied to provide the coding, which reduces the number of pins available for interfacing between the modules and the instrument mainframe. While a modular instrument typically includes a USB (universal serial bus) or other type of primary communication link between the modules and the instrument mainframe, a second known method relies on a secondary communication link between the modules and the instrument mainframe to establish the location of modules, which adds complexity to the modular instrument.

In view of the shortcomings of these known methods, there is a need for a module locator that establishes the locations of modules within an instrument mainframe without occupying multiple connector pins or contacts of a module and without increasing complexity of the modular instrument.

### SUMMARY OF THE INVENTION

A module locator constructed according to a first embodiment of the present invention has a generator that provides to each of the one or more module slots in a mainframe, a signal having a unique signature. Each module interfaced with a module slot has an associated receiver that receives the signal through the module slot and reads the unique signature of the signal provided by the generator. The unique signatures read by the receivers are typically reported to a host processor associated with the mainframe when queried, so that the location of the module can be established. A method for locating modules within a series of module slots of the mainframe is constructed according to an alternative embodiment of the present invention.

### BRIEF DESCRIPTION OF THE DRAWINGS

FIG. 1 shows a module locator constructed according to a first embodiment of the present invention.

FIGS. 2A-2B show examples of a generator suitable for inclusion in the module locator of FIG. 1.

FIG. 3 is a flow diagram of a method for locating modules within a series of module slots of a mainframe, constructed according to an alternative embodiment of the present invention.

### DETAILED DESCRIPTION OF THE EMBODIMENT

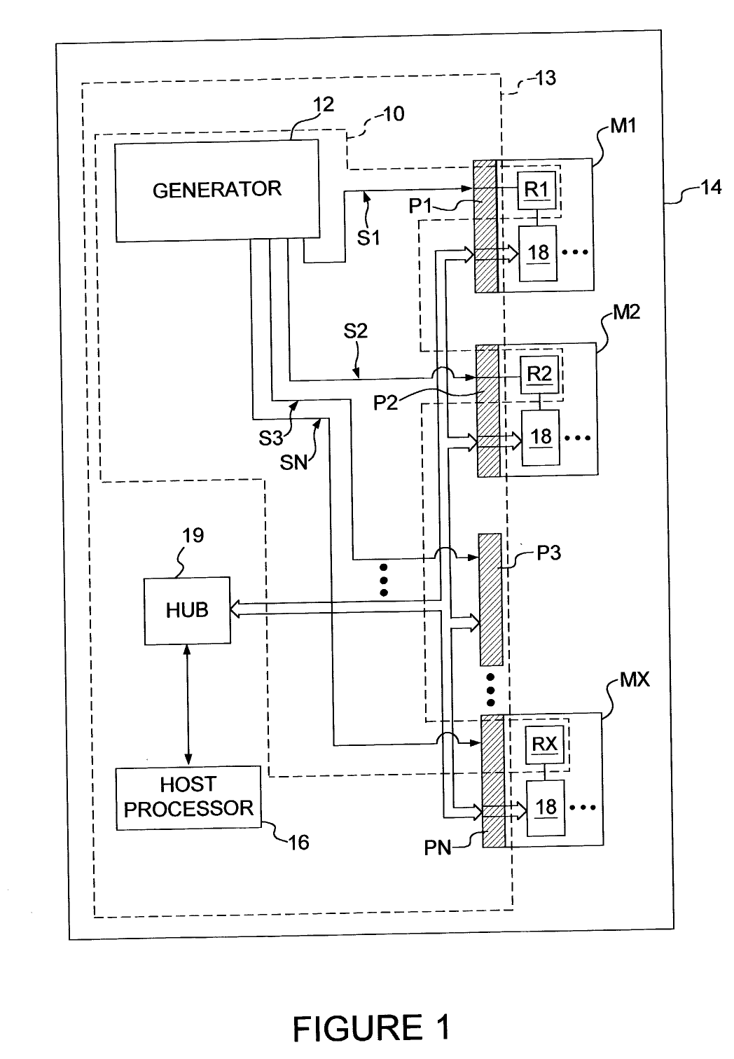

FIG. 1 shows a module locator 10 constructed according to a first embodiment of the present invention that includes a generator 12 and one or more receivers R1-RX. The module locator 10 identifies the location of one or more modules M1-MX within a series of module slots P1-PN of a mainframe 13 of a modular instrument 14. While the modular instrument 14 is typically a test, measurement or communication system that includes the modules M1-MX plugged into, in communication with, or otherwise interfaced with the mainframe 13 via the series of module slots P1-PN, the modular instrument 14 is alternatively a system or product having a motherboard included in the mainframe 13 and a series of connectors included as module slots P1-PN suitable for receiving circuit boards or other types of modules M1-MX. In the example shown in FIG. 1, modules M1, M2 and MX occupy module slots P1, P2 and PN, respectively, and module slot P3 is unoccupied.

The modules M1-MX are the various subsystems that form the modular instrument 14 when the modules M1-MX are combined and interfaced with the mainframe 13. An example of a modular instrument 14 that includes such subsystems is the model E7403 Spectrum Analyzer, provided by AGILENT TECHNOLOGIES, INC., Palo Alto, Calif. Alternatively, each of the modules M1-MX is a test, measurement, or communication system that is combined with other systems in the mainframe 13. An example of a modular instrument 14 that includes such systems is the model 86100B Digital Communications Analyzer, provided by AGILENT TECHNOLOGIES, INC., Palo Alto, Calif.

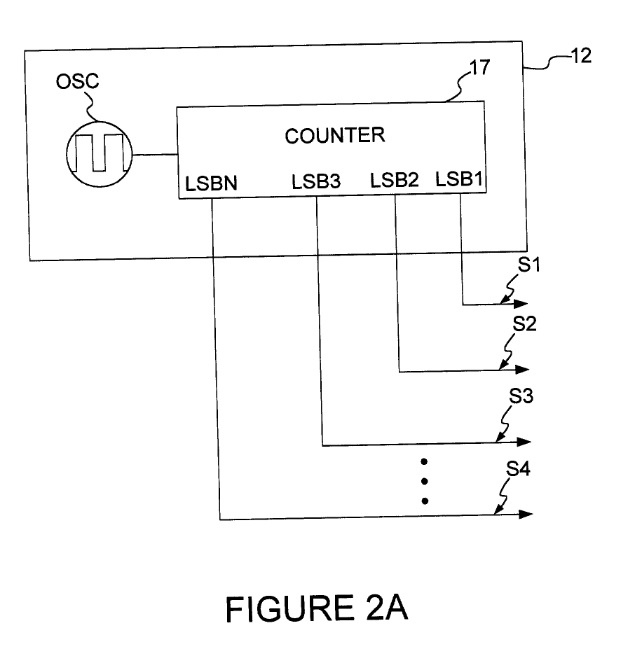

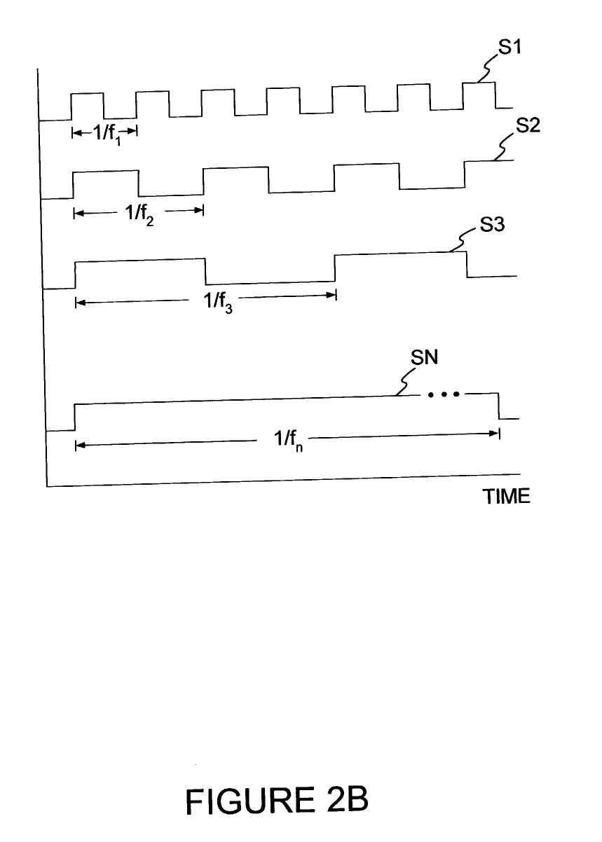

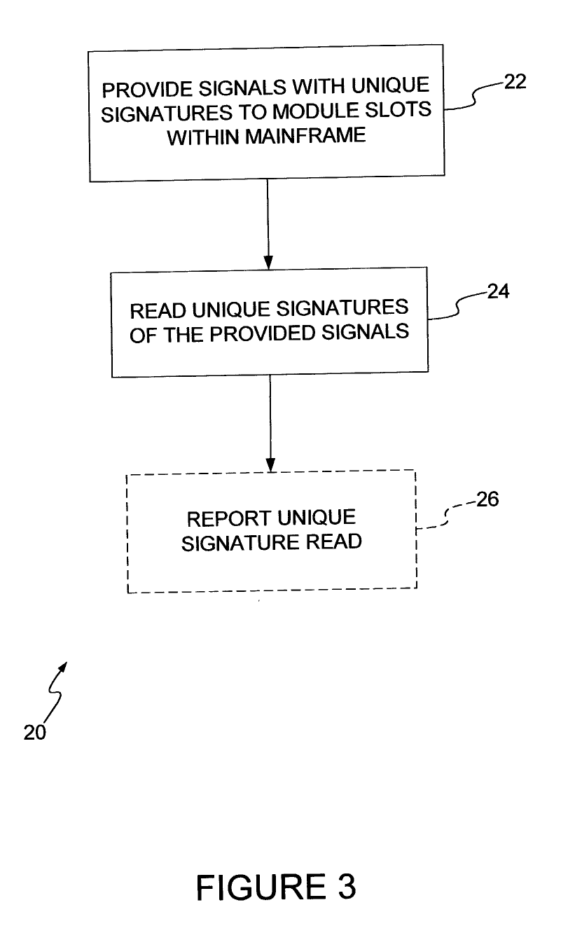

The generator 12 is a waveform generator, synthesizer, function generator, circuit, system, or other signal source suitable for providing one or more signals S1-SN, wherein each signal has a unique signature. The unique signature of each of the signals S1-SN is typically established based on envelop shape, frequency, amplitude, phase, pulse sequences, pulse widths. However, the unique signatures can be based on any other characteristics of the signals Si-SN that enable the signals S1-SN to each be distinguished by the receivers R1-RX. In the example shown in FIGS. 2A-2B, each of the signals S1-SN is a pulse sequence having a unique pulse frequency f1-fn. The generator 12 in this example is implemented via an oscillator OSC clocking a counter 17, wherein the signals S1-SN are provided by the bit outputs LSB1-LSBN of the counter 17. The bit outputs LSB1-LSBN are each coupled to a predesignated one of the module slots P1-PN of the mainframe 13. In this example, bit output LSB1 is coupled to module slot P1, bit output LSB2 is coupled to module slot P2, bit output LSB3 is coupled to module slot P3 and so on.

While the generator 12 is shown as a single element providing all of the signals S1-SN to the corresponding module slots P1-PN, the generator 12 is alternatively more than one waveform generator, synthesizer, function generator, circuit, system, or other signal source, each of which provides one or more of the signals S1-SN that are applied to the series of module slots P1-PN. For example, the generator 12 is a series of N signal sources, where N is an integer, each providing a corresponding one of the signals S1-SN to a corresponding module slot in the series of module slots P1-PN.

Each of the receivers R1-RX included in the module locator 10 is associated with a corresponding one of the modules M1-MX. Typically, a receiver is incorporated in each one of the modules M1-MX and the receivers R1-RX read the unique signatures of one or more of the signals S1-SN applied to the module slots P1-PN. For example, the receiver R1 reads the unique signature of the waveform S1 applied to the module slot M1, the receiver R2 reads the unique signature of the waveform S2 applied to the module slot M2, and so on.

The type of the receivers R1-RX included in the module locator 10 is selected based on the characteristics of the unique signatures so that the receivers R1-RX have the capability to distinguish between the unique signatures of the signals S1-SN. In the example of FIGS. 2A-2B, where the signals S1-SN are pulse sequences each having a unique pulse frequency, the receivers R1-RX each include a frequency counter that reads the unique pulse frequency. In other examples, the unique signatures of the signals S1-SN are based on envelop shape or amplitude and the receivers R1-RX include envelope detectors or amplitude demodulators, the unique signatures of the signals S1-SN are based on phase of the signals S1-SN and the receivers R1-RX include phase detectors, or the unique signatures of the signals S1-SN are based on pulse sequences or pulse widths of the signals S1-SN and the receivers R1-RX include pulse counters or decoders.

Once the receivers R1-RX read the unique signatures of one or more of the signals S1-SN, the locations of one or more of the modules M1-MX associated with the receivers R1-RX within the series of module slots P1-PN can be established, since each of the signals S1-SN is applied to a designated one of the module slots P1-PN. Typically, a host processor 16 in the mainframe 13 queries the modules M1-MX. In response, the modules M1-MX report the corresponding module locations to the host processor 16 based on the unique signatures read by the receivers R1-RX. In the example shown in FIG. 1, the host processor 16 queries one or more of the modules M1-MX through a USB (universal serial bus) type of hub 19 and each module includes a USB type of controller 18 interfacing with a corresponding one of the receivers R1-RX. The receiver RX, for example, reports the unique pulse frequency fn via the controller 18 of the module MX, indicating to the host processor 16 that the module MX is located in the module slot PN. Similarly, the other receivers report the unique signatures via the controllers 18 of the corresponding modules M1-MX to indicate to the host processor 16 which of module slots P1-PN the modules M1-MX are located in.

The receiver and the controller 18 in each of the modules M1-MX are optionally integrated into an FPGA (field programmable gate array), ASIC (application specific integrated circuit) or other type of circuit. When alternative types of buses or communication links, besides a USB type link, are included in the modular instrument 14, the controllers 18 provide the suitable interface between the receivers R1-RX and the host processor 16.

FIG. 2 is a flow diagram of a method 20 constructed according to an alternative embodiment of the present invention, for the locating modules M1-MX within the series of module slots P1-PN. Step 22 of the method 20 includes providing the signals S1-SN having the unique signatures to one or more of the module slots P1-PN, so that the one or more module slots P1-PN each has applied to it, a designated one of the signals S1-SN with a unique signature. The unique signatures are based on any signal characteristics that make the signals S1-SN distinguishable from each other. Typically, the unique signatures of the signals S1-SN are based on envelop shape, frequency, amplitude, phase, pulse sequences, or pulse widths. In one example, as shown in FIG. 2B, the unique signatures of the signals S1-SN are based on pulse sequences having unique pulse frequencies.

Step 24 includes reading the unique signatures of one or more of the signals S1-SN that are applied to the module slots P1-PN. Reading the unique signatures enables the signals S1-SN to be distinguished from each other and establishes the locations of one or more modules M1-MX within the module slots P1-PN, since each module slot receives a designated one of the signals S1-SN. Optional step 26 includes reporting the unique signature that is read in step 24. Typically, the unique signatures are reported in response to queries.

While the embodiments of the present invention have been illustrated in detail, it should be apparent that modifications and adaptations to these embodiments may occur to one skilled in the art without departing from the scope of the present invention as set forth in the following claims.

What is claimed is:

1. A system for locating at least one module within a series of module slots, comprising:
a generator providing to at least one module slot in the series of module slots, a corresponding signal having a unique signature; and
at least one receiver, each of the at least one receivers associated with a corresponding one of the at least one modules, reading the unique signatures of the signals provided to the at least one module slot.

2. The system of claim 1 wherein the at least one receiver interfaces with a corresponding controller, reporting the unique signature read by the at least one receiver.

3. The system of claim 1 wherein each of the signals provided by the generator has a unique signature based on at least one of an envelop shape, a frequency, an amplitude, a phase, a pulse sequence, and a pulse width.

4. The system of claim 1 wherein each of the signals provided by the generator has a unique pulse frequency.

5. The system of claim 1 wherein the generator includes a counter having multiple bit outputs each providing a corresponding one of the signals having a unique signature.

6. The system of claim 4 wherein each of the at least one receivers includes a frequency counter.

7. The system of claim 5 wherein each of the at least one receivers includes a frequency counter.

8. The system of claim 6 wherein the frequency counters included in each of the at least one receivers is implemented in a field programmable gate array.

9. The system of claim 7 wherein the frequency counters included in each of the at least one receivers are implemented in a field programmable gate array.

10. A method for locating at least one module within a series of module slots, comprising:
providing to at least one module slot in the series of module slots, a corresponding signal having a unique signature; and
reading the unique signatures of the signals provided to the at least one module slot.

11. The method of claim 10 further comprising reporting the unique signatures of the signals provided to the at least one module slot that are read.

12. The method of claim 11 wherein reporting the unique signatures of the signals provided to the at least one module slot is responsive to a query from a host processor.

13. The method of claim 10 wherein the provided signals have unique signatures based on at least one of an envelop shape, a frequency, an amplitude, a phase, a pulse sequence, and a pulse width.

14. The method of claim 10 wherein each of the provided signals has a unique pulse frequency.

15. The method of claim 11 wherein the signals provided to the at least one module slot are generated by a counter.

16. The method of claim 14 wherein reading the unique signatures of the signals provided to the at least one module slots includes counting the frequency of the provided signals.

17. The method of claim 15 wherein reading the unique signatures of the signals provided to the at least one module slots includes counting the frequency of the provided signals.
